(19) United States
(12) Patent Application Publication
(10) Pub. No.: US 2006/0063499 A1
(43) Pub. Date: Mar. 23, 2006

(54) VHF band receiver

(76) Inventor: Hiroshi Miyagi, Niigata (JP)

Correspondence Address: DELLETT & WALTERS, P. O. BOX 82788, PORTLAND, OR, 97282-0788, US

(21) Appl. No.: 11/219,333

(22) Filed: Sep. 2, 2005

(30) Foreign Application Priority Data
Sep. 7, 2004 (JP) 2004-259594

(51) Int. Cl. H04B 1/18

(52) U.S. Cl. 455/179.1; 455/188.1

(57) ABSTRACT

An object of the invention is to provide a VHF band receiver in which the degree of freedom in installing an antenna is large and in which miniaturization is easy. An FM receiver 100 includes: a tuning circuit which selectively allows passage of signals of a tuning frequency and neighboring frequencies thereof from among received broadcast waves; a local oscillator circuit 13 which generates a local oscillation signal; and a mixer circuit 12 which mixes a frequency of a local oscillation signal generated by the local oscillator circuit 13 and a frequency of a high frequency signal obtained by a tuning operation performed by the tuning circuit. The tuning circuit includes an antenna coil 1 wound around a magnetic core, and a variable-capacitance circuit 2, together with the antenna coil 1, constituting a resonant circuit, whereby the VHF band tuning frequency is set.

### BACKGROUND OF THE INVENTION

1. Field of the Invention

The present invention relates to a VHF band receiver which receives a VHF band signal.

2. Description of the Prior Art

In conventional receivers which receive a VHF band signal such as an FM broadcast signal, a rod antenna or a wire antenna using an earphone cord or the like is used. However, such an antenna needs to be exposed outside the housing of the receiver, so it is easy to be damaged. As a conventional technique for solving this problem, there has been known a receiver which uses a helical loop-shaped surface radiation antenna having a metal conductor spirally wound around a core member made of a rectangular frame type conductive material (refer to Japanese Patent Laid-Open No. 9-93027). By using this antenna, the size of the entire receiver including the antenna can be reduced compared to when a rod antenna or a wire antenna is used.

While the size of the above described helical loop-shaped surface radiation antenna can be reduced compared to a rod antenna etc., a relatively large space occupied by the antenna needs to be secured when it is used in a receiver incorporated into a mobile device such as a mobile phone; therefore, the size of the antenna is not small enough. Also, since a relatively large installation space is needed, the installation location is not easy to be changed; thus, the degree of freedom in installing the antenna is small.

### SUMMARY OF THE INVENTION

To address such problems, the present invention has been devised, and an object of the present invention is to provide a VHF band receiver in which the degree of freedom in installing an antenna is large and in which miniaturization is easy.

To solve the above problems, a VHF band receiver according to the present invention includes: a tuning circuit which selectively allows passage of signals of a tuning frequency and neighboring frequencies thereof from among received signals; a local oscillator circuit which generates a local oscillation signal; and a mixer circuit which mixes a frequency of a local oscillation signal generated by the local oscillator circuit and a frequency of a high frequency signal obtained by a tuning operation performed by the tuning circuit, wherein the tuning circuit includes an antenna coil wound around a magnetic core, and a capacitive circuit, together with the antenna coil, constituting a resonant circuit, whereby the VHF band tuning frequency is set. Thus, by using an antenna constituted of a magnetic core and an antenna coil, a small antenna can be realized, so the degree of freedom in installing an antenna is increased, and at the same time the miniaturization of the entire VHF band receiver is easy. For example, when an antenna for receiving an FM broadcast wave having an impedance of 300 Ω is designed, a magnetic core having a length of about 1 cm can be used. Accordingly, considerable miniaturization is possible compared to a conventional rod antenna, wire antenna, helical loop-shaped surface radiation antenna and the like.

Also, it is preferable that the capacitive circuit described above is a variable-capacitance circuit with the electrostatic capacitance thereof variable, and that there is further provided a control section which performs a setting operation of causing the tuning frequency to coincide with a frequency of a signal to be received. Accordingly, the tuning circuit can selectively pass a signal having a frequency in the vicinity of the frequency of a desired signal, so sensitivity and selectivity can be improved compared to a case where a fixed tuning frequency is set, such as a case where a conventional rod antenna or the like is used.

Also, it is preferable that the oscillation frequency of the local oscillator circuit described above can be varied and the control section performs a control of interlocking the oscillation frequency of the local oscillator circuit and the tuning frequency of the tuning circuit to vary the oscillation frequency of the local oscillator circuit. Thus, by interlocking the tuning frequency of the tuning circuit and the oscillation frequency of the local oscillator circuit, it becomes possible to realize a super-heterodyne FM receiver with further improved sensitivity and selectivity. For example, while maintaining a frequency difference corresponding to an intermediate frequency, the tuning frequency of the tuning circuit and the oscillation frequency of the local oscillator circuit are varied.

Also, it is preferable that the variable-capacitance circuit described above is formed on a semiconductor substrate having formed thereon the control section. It is thus possible to construct a tuning circuit or FM receiver with the tuning frequency thereof variable, in which the antenna coil wound around a magnetic core alone is an external component, thereby making it possible to reduce the size of the entire FM receiver. In addition, the control by the control section formed on the same semiconductor substrate of which the variable-capacitance circuit is formed thereon becomes easy, and at the same time the number of external components can be reduced.

Also, it is preferable that one end of the antenna coil described above is connected to the ground and the other end thereof is directly connected to the capacitive circuit. Only the one end of the antenna coil is directly connected to the capacitive circuit, so wiring can be simplified. Particularly, when the capacitive circuit is formed on the semiconductor substrate, it is sufficient to have only one dedicated pad used to directly connect the antenna coil and capacitive circuit, so the number of pads on the semiconductor substrate can be reduced.

Also, it is preferable that the antenna coil described above has a center tap connected to the ground and both ends thereof are directly connected to both ends of the capacitive circuit, respectively. Alternatively it is preferable that the capacitive circuit described above has first and second capacitive elements, having the capacitance thereof set to approximately the same value, connected to each other in series, and the connection point between the first and second capacitive elements is connected to the ground, and both ends of the capacitive circuit are directly connected to both ends of the antenna coil, respectively. Accordingly, it becomes possible to increase the amplitude of a signal outputted from the tuning circuit constituted of the antenna coil and capacitive circuit, so sensitivity and selectivity can be improved.

The VHF band receiver according to the present invention includes a tuning circuit which selectively allows passage of signals of a tuning frequency and neighboring frequencies thereof from among received VHF band signals, and a control section which sets the tuning frequency of the tuning circuit, wherein the tuning circuit includes an antenna coil wound around a magnetic core, and a plurality of capacitors to be selectively connected to the antenna coil, and the control section varies the selection of the plurality of capacitors to thereby make variable the VHF band tuning frequency determined by the antenna coil and the capacitors selectively connected to the antenna coil. Thus, by using an antenna constituted of a magnetic core and an antenna coil, a small antenna can be realized, so the degree of freedom in installing an antenna is increased, and at the same time the miniaturization of the entire VHF band receiver is easy. Also, by selecting capacitors to be connected to the antenna coil, the tuning circuit can pass selectively a signal having a frequency in the vicinity of the frequency of a desired signal, so sensitivity and selectivity can be improved compared to a case where a fixed tuning frequency is set, such as a case where a conventional rod antenna is used.

Also, it is preferable that a plurality of switches for turning on and off the connection of the capacitors are connected in series to at least one part of the plurality of capacitors described above, and the control section varies the on and off state of the switches to thereby vary the selection of the plurality of capacitors. Accordingly, the connection of the capacitors can easily be varied.

Also, it is preferable that there are provided a plurality of sets of series circuits having the one capacitor and one switch described above connected in series to each other and the plurality of sets of series circuits are connected in parallel to the antenna coil. Accordingly, it is possible to select the capacitors to be connected in parallel to the antenna coil, so the resonance frequency of a parallel resonant circuit constituted of an antenna coil and a capacitor, i.e., the tuning frequency of the tuning circuit can easily be varied.

Also, it is preferable that there are further provided a local oscillator circuit whose oscillation frequency is set by the control section described above, and a mixer circuit which mixes a frequency of a local oscillation signal generated by the local oscillator circuit and a frequency of a high frequency signal obtained by a tuning operation performed by the tuning circuit. By the control section controlling both the local oscillator circuit and tuning circuit, the frequency of the local oscillator signal and the tuning frequency can be interlocked and varied.

Also, it is preferable that the plurality of capacitors and the plurality of switches described above are formed on a semiconductor substrate having formed thereon the control section. Accordingly, almost all components except the antenna coil, the loudspeaker, and so on, can be integrally formed on the semiconductor substrate, so the miniaturization and cost reduction of the entire VHF band receiver are possible. Also, by forming the control section on the same semiconductor substrate as with the plurality of capacitors and switches, the control of turning on and off the switches by the control section becomes easy, and at the same time the number of external components can be reduced. In addition, the variations of relative ratio between the plurality of capacitors can be reduced.

Also, it is preferable that one end of the antenna coil described above is connected to the ground and the other end thereof is directly connected to the plurality of capacitors. It is sufficient to directly connect only one end of the antenna coil to the plurality of capacitors, so wiring can be simplified. Particularly, when the plurality of capacitors are formed on a semiconductor substrate, it is sufficient to have only one dedicated pad used to directly connect the antenna coil and the plurality of capacitors, so the number of pads on the semiconductor substrate can be reduced.

Also, it is preferable that the antenna coil described above has a center tap connected to the ground and both ends thereof are directly connected to both ends of the plurality of capacitors, respectively. Alternatively it is preferable that the plurality of capacitors described above each have two capacitors, having the capacitance thereof set to approximately the same value, connected to each other in series, and the connection point between the two capacitors is connected to the ground, and both ends of a series circuit constituted of the two capacitors are directly connected to both ends of the antenna coil, respectively. Accordingly, it becomes possible to increase the amplitude of a signal outputted from the tuning circuit constituted of the antenna coil and the plurality of capacitors, so sensitivity and selectivity can be improved.

### BRIEF DESCRIPTION OF THE DRAWINGS

FIG. 1 is a diagram showing a configuration of an FM receiver according to an embodiment;

FIG. 2 is a diagram showing a fragmentary configuration of an FM receiver using a balanced type antenna coil;

FIG. 3 is a diagram showing a fragmentary configuration of a variation of the FM receiver; and

FIG. 4 is an explanatory view of a variation in which the ratio of electrostatic capacitance between capacitors is set to a power-of-two value.

### DETAILED DESCRIPTION OF THE PREFERRED EMBODIMENTS

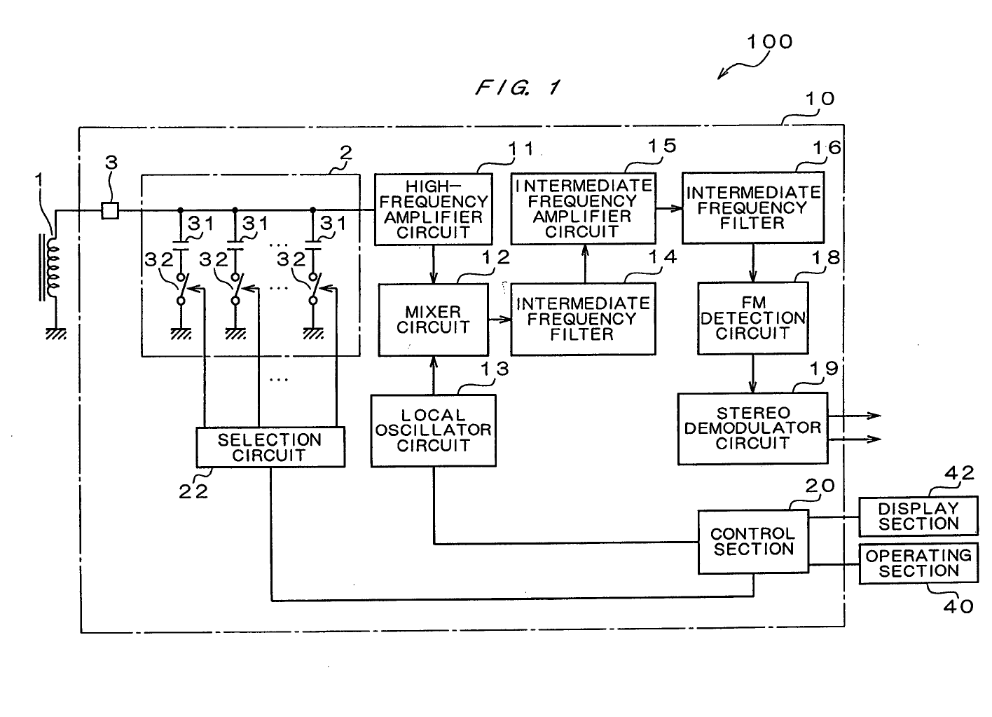

An FM receiver according to an embodiment of the present invention will be described below in detail. FIG. 1 is a diagram showing a configuration of an FM receiver according to an embodiment. The FM receiver 100 shown in FIG. 1 includes an antenna coil 1, a variable-capacitance circuit 2, a high-frequency amplifier circuit 11, a mixer circuit 12, a local oscillator circuit 13, intermediate frequency filters 14 and 16, an intermediate frequency amplifier circuit 15, an FM detection circuit 18, a stereo demodulator circuit 19, a control section 20 and a selection circuit 22. In this configuration, the constituent components except the antenna coil 1 are formed as a single-chip component 10 on a semiconductor substrate by a CMOS process or a MOS process. The connection between the single-chip component 10 and antenna coil 1 is made via a pad 3 formed on the semiconductor substrate.

The antenna coil 1 is wound around a ferrite magnetic core. For example, a ferrite magnetic core having a diameter of 2 to 3 mm and a length of about 1 cm is used, and by winding a wire around the core, an antenna coil 1 having an impedance of about several kΩ is formed.

The variable-capacitance circuit 2, which is a capacitive circuit, is constituted of a plurality of capacitors 31 and a plurality of switches 32. A plurality of sets of series circuits each having the one capacitor 31 and one switch 32 constitute the variable-capacitance circuit 2, and each of the plurality of sets of series circuits is connected in parallel to the antenna coil 1. The on and off state of each of the switches 32 can be set independently of each other; a capacitor 31 connected to a switch 32 being turned on is selectively connected to the antenna coil 1. The switch 32 is realized by using, for example, an analog switch having the points between each source and drain of a p-channel FET and an n-channel FET connected in parallel to each other.

As described above, an LC resonant circuit is formed of the antenna coil 1 and variable-capacitance circuit 2 connected in parallel to each other; the antenna coil 1 and variable-capacitance circuit 2 operate as a tuning circuit which selectively allows passage of a tuning frequency corresponding to the resonance frequency of the resonant circuit and neighboring broadcast waves thereof.

The high-frequency amplifier circuit 11 amplifies a signal outputted from the variable-capacitance circuit 2. The local oscillator circuit 13 generates a local oscillation signal which is distant by an intermediate frequency from the frequency of a desired broadcast wave.

The control section 20, which controls the entire operation of the FM receiver 100, sets the frequency of a local oscillation signal generated by the local oscillator circuit 13 to thereby perform a channel select operation of determining a broadcast wave to be received. The control section 20, constituted of a CPU, a memory, etc., performs the control operation by executing a predetermined program.

The selection circuit 22 performs predetermined decoding processing on setting data supplied from the control section 20 and thereby generates a selection signal for controlling the turning on and off of each of the switches 32 within the variable-capacitance circuit 2. If the number of the switches 32 is m, the number of the selection signals is also m. The voltage of each of the selection signals is set to a low level or a high level. For example, when a selection signal having a voltage of a low level is received, a switch 32 is turned off; when a selection signal having a voltage of a high level is received, the switch 32 is turned on. Only one from among the selection signals may be selectively set to a high level, or alternatively a combination of the two or more selection signals may be set to a high level.

The mixer circuit 12 mixes a signal outputted from the high-frequency amplifier circuit 11 and a local oscillation signal outputted from the local oscillator circuit 13, and outputs a signal corresponding to the difference (or sum) component therebetween. The intermediate frequency filters 14 and 16, disposed at the preceding and rear stages of the intermediate frequency amplifier circuit 15, extracts only a predetermined band component from the intermediate frequency signal supplied thereto. The intermediate frequency amplifier circuit 15 amplifies part of the intermediate frequency signal which passes the intermediate frequency filters 14 and 16. The FM detection circuit 18 performs FM detection processing on a signal having constant amplitude which has passed a limiter circuit (not shown) after outputted from the rear-stage intermediate frequency filter 16. The stereo demodulator circuit 19 performs stereo demodulation processing on a composite signal obtained by the FM detection and outputted from the FM detection circuit 18 to generate L and R signals.

An operating section 40, used for the user to perform a channel selecting operation, a sound volume setting operation, and so on, includes various operating keys and knobs required for the operations. A display section 42, used to notify various sorts of information to the user, displays the frequency of a received broadcast wave and the name of the broadcasting station corresponding to this broadcast wave, and the level of sound volume, and so on.

Thus, in the FM receiver 100 according to the present embodiment, by using an antenna constituted of a magnetic core and an antenna coil 1, a small antenna can be realized, so the degree of freedom in installing an antenna is increased, and at the same time the miniaturization of the entire FM receiver 100 is easy. For example, when an antenna for the FM receiver having an impedance of 300 Ω is designed, a magnetic core having a length of about 1 cm can be used. Accordingly, considerable miniaturization is possible compared to a conventional rod antenna, wire antenna, helical loop-shaped surface radiation antenna and the like.

The control section 20 performs a setting operation of causing the tuning frequency to coincide with a frequency of a broadcast wave to be received, so a signal having a frequency in the vicinity of the frequency of a desired broadcast wave can be selectively passed. Accordingly, sensitivity and selectivity for the entire FM frequency bandwidth can be improved compared to a case where a fixed tuning frequency is set, such as a case where a conventional rod antenna or the like is used. Also, the control section 20 performs a control of interlocking the oscillation frequency of the local oscillator circuit 13 and the tuning frequency of the tuning circuit to vary the oscillation frequency of the local oscillator circuit. Thus, by interlocking the tuning frequency of the tuning circuit and the oscillation frequency of the local oscillator circuit 13, it becomes possible to realize a super-heterodyne FM receiver 100 with further improved sensitivity and selectivity.

Also, the variable-capacitance circuit 2 and other circuits are formed on a semiconductor substrate having formed thereon the control section 20. It is thus possible to construct the tuning circuit or the FM receiver 100 with the tuning frequency thereof variable, in which the antenna coil 1 wound around a magnetic core alone is an external component, thereby making it possible to reduce the size of the entire FM receiver 100. In addition, by forming the control section 20 on the same semiconductor substrate as with the plurality of capacitors 31 and the plurality of switches 32, the selection control of the switches 32 by the control section 20 becomes easy, and at the same time the number of external components can be reduced. Also, the variations of relative ratio between the plurality of capacitors 31 can be reduced.

Also, by employing an unbalanced type configuration in which one end of the antenna coil 1 is connected to the ground and the other end thereof is directly connected to the variable-capacitance circuit 2, wiring can be simplified. Particularly, when the variable-capacitance circuit 2 is formed on the semiconductor substrate, it is sufficient to have only one dedicated pad 3 used to directly connect the antenna coil 1 and variable-capacitance circuit 2, so the number of pads on the semiconductor substrate can be reduced.

Also, the variable-capacitance circuit 2 is constituted of the plurality of capacitors 31 and the plurality of switches 32 and the turning on and off of the switches 32 is controlled by the control section 20, whereby the connection of the capacitors 31 can be easily selected and the electrostatic capacitance of the entire variable-capacitance circuit 2 can be easily varied.

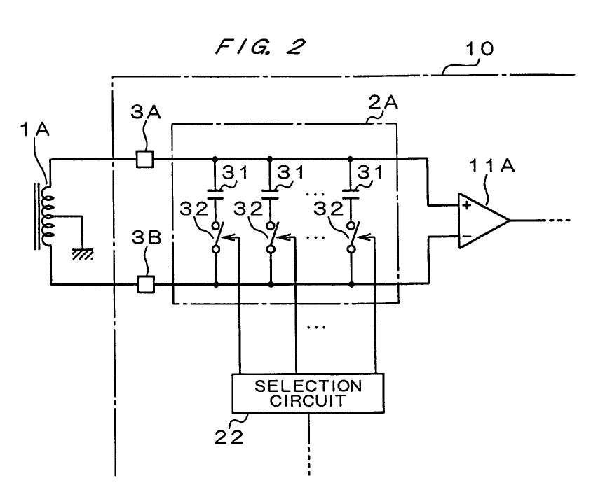

In the FM receiver 100 described above, the unbalanced type antenna coil 1 having one end thereof connected to the ground is used. However, a balanced type antenna coil may be used. FIG. 2 is a diagram showing a fragmentary configuration of an FM receiver using a balanced type antenna coil. The FM receiver 100 shown in FIG. 2 includes a balanced type antenna coil 1A, a variable-capacitance circuit 2A constituting a tuning circuit together with the antenna coil 1A, and a high-frequency amplifier circuit 11A constituted of a differential amplifier circuit. In other aspects, the configuration is the same as that of the FM receiver 100 shown in FIG. 1, and hence an illustration and detailed explanation thereof in FIG. 2 are omitted.

The antenna coil 1A is wound around a ferrite magnetic core, and a center tap is withdrawn from the central position, and is connected to the ground. Both ends of the antenna coil 1A are connected to the variable-capacitance circuit 2A via pads 3A and 3B formed on the semiconductor substrate, respectively.

The variable-capacitance circuit 2A, having approximately the same configuration as with the variable-capacitance circuit 2 shown in FIG. 1, includes a plurality of capacitors 31 and a plurality of switches 32. While one end of a series circuit constituted of a capacitor 31 and switch 32 is connected to the ground in the variable-capacitance circuit 2, both ends of a series circuit constituted of a capacitor 31 and switch 32 are connected to the pads 3A and 3B in the variable-capacitance circuit 2A. In this case, the series circuit is not connected to the ground.

Thus, by using the balanced type antenna coil 1A, the positive and negative amplitudes relative to the voltage of the center tap connected to the ground can be combined, so the gain of a broadcast wave signal supplied from the tuning circuit to the high-frequency amplifier circuit 11A can be increased by 6 dB. The high-frequency amplifier circuit 11A differentially amplifies a broadcast wave signal outputted from the variable-capacitance circuit 2A and supplies the resultant signal to the mixer circuit 12 at the rear stage. Accordingly, dynamic range can be widened.

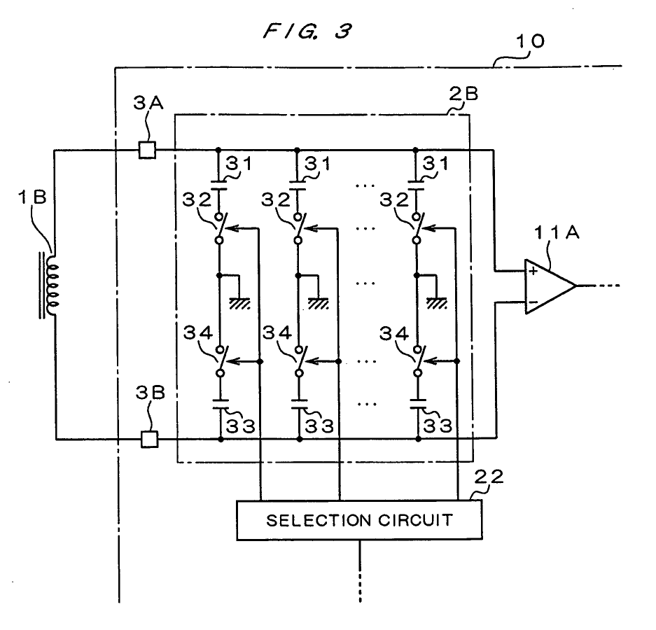

FIG. 3 is a diagram showing a fragmentary configuration of a variation of the FM receiver. In the FM receiver shown in FIG. 2, by arranging a center tap in the antenna coil 1A and connecting it to the ground, a balanced type configuration is realized. As shown in FIG. 3, however, by arranging a center tap in a capacitor within the variable-capacitance circuit and connecting it to the ground, a similar balanced type configuration can also be realized.

The FM receiver shown in FIG. 3 includes an antenna coil 1B, a variable-capacitance circuit 2B constituting a tuning circuit together with the antenna coil 1B, and a high-frequency amplifier circuit 1A constituted of a differential amplifier circuit. In other aspects, the configuration is the same as that of the FM receiver 100 shown in FIG. 1, and hence an illustration and detailed explanation thereof in FIG. 3 are omitted.

The antenna coil 1B is wound around a ferrite magnetic core. Both ends of the antenna coil 1B are connected to the variable-capacitance circuit 2B via pads 3A and 3B formed on a semiconductor substrate, respectively.

In addition to the plurality of capacitors 31 and switches 32, the variable-capacitance circuit 2B includes the same number of a plurality of capacitors 33 and switches 34 as the capacitors 31 and switches 32. A plurality of sets of series circuits constituted of the capacitors 31, switches 32 and 34, and capacitors 33 are connected between the pads 3A and 3B. In this series circuit, a center tap is arranged at the connection point between the switches 32 and 34, and the center tap is connected to the ground. By setting the electrostatic capacitance of the capacitors 31 and 33 being capacitive elements included in one series circuit to the same value and at the same time, turning on and off the two switches 32 and 34 connected to the capacitors 31 and 33 at the same timing, a broadcast wave signal having a large amplitude, as with the configuration shown in FIG. 2, can be outputted from both ends of this series circuit.

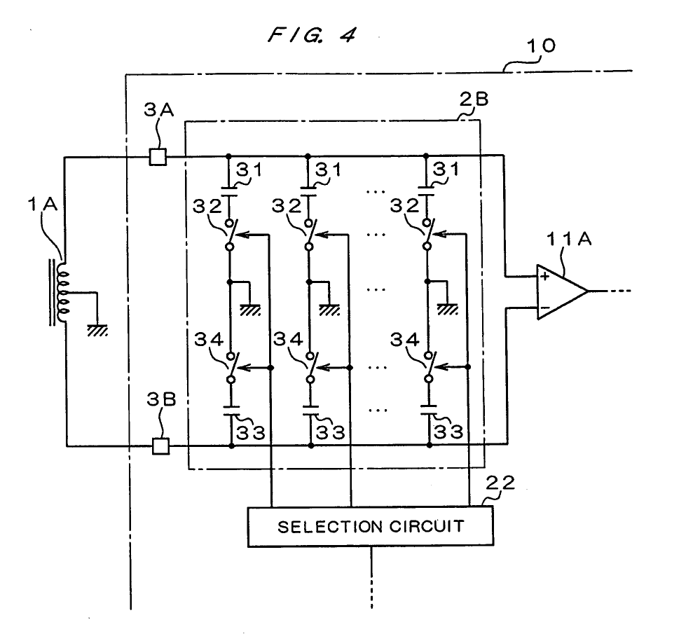

Also, the configuration shown in FIG. 2 and that shown in FIG. 3 may be combined. Specifically, as shown in FIG. 4, a balanced type tuning circuit may be constructed by combining the antenna coil 1A shown in FIG. 2 and the variable-capacitance circuit 2B shown in FIG. 3.

The present invention is not limited to the embodiment described above, and various modifications to the embodiment are possible without departing from the gist of the invention. For example, in the embodiment described above, applications to FM receiver were described, but the invention can also be applied to VHF receiver which receives other signals within the VHF band. In this case, the demodulation scheme of the VHF receiver is not limited to FM demodulation scheme; AM demodulation scheme and digital demodulation scheme may be employed.

What is claimed is:

1. A VHF band receiver comprising:
a tuning circuit which selectively allows passage of signals of a tuning frequency and neighboring frequencies thereof from among received signals;
a local oscillator circuit which generates a local oscillation signal; and
a mixer circuit which mixes a frequency of a local oscillation signal generated by the local oscillator circuit and a frequency of a high frequency signal obtained by a tuning operation performed by the tuning circuit,
wherein the tuning circuit includes an antenna coil wound around a magnetic core, and a capacitive circuit, together with the antenna coil, constituting a resonant circuit, whereby the VHF band tuning frequency is set.

2. The VHF band receiver according to claim 1, further comprising a control section which performs a setting operation of causing the tuning frequency to coincide with a frequency of a signal to be received, wherein the capacitive circuit is a variable-capacitance circuit with the electrostatic capacitance thereof variable.

3. The VHF band receiver according to claim 2, wherein the oscillation frequency of the local oscillator circuit can be varied, and the control section performs a control of interlocking the oscillation frequency of the local oscillator circuit and the tuning frequency of the tuning circuit to vary the oscillation frequency of the local oscillator circuit.

4. The VHF band receiver according to claim 2, wherein the variable-capacitance circuit is formed on a semiconductor substrate having formed thereon the control section.

5. The VHF band receiver according to claim 1, wherein one end of the antenna coil is connected to the ground and the other end thereof is directly connected to the capacitive circuit.

6. The VHF band receiver according to claim 1, wherein the antenna coil has a center tap connected to the ground, and both ends thereof are directly connected to both ends of the capacitive circuit, respectively.

7. The VHF band receiver according to claim 1, wherein the capacitive circuit has first and second capacitive elements, having the capacitance thereof set to approximately the same value, connected to each other in series, and the connection point between the first and second capacitive elements is connected to the ground, and both ends of the capacitive circuit are directly connected to both ends of the antenna coil, respectively.

8. The VHF band receiver according to claim 4, wherein constituent components except the antenna coil wound around the magnetic core are integrally formed on the semiconductor substrate by a CMOS process or a MOS process.

9. A VHF band receiver comprising:
a tuning circuit which selectively allows passage of signals of a tuning frequency and neighboring frequencies thereof from among received VHF band signals; and
a control section which sets the tuning frequency of the tuning circuit,
wherein the tuning circuit includes an antenna coil wound around a magnetic core, and a plurality of capacitors to be selectively connected to the antenna coil, and the control section varies the selection of the plurality of capacitors to thereby make variable the VHF band tuning frequency determined by the antenna coil and the capacitors selectively connected to the antenna coil.

10. The VHF band receiver according to claim 9, wherein a plurality of switches for turning on and off the connection of the capacitors are connected in series to at least one part of the plurality of capacitors, and the control section varies the on and off state of the switches to thereby vary the selection of the plurality of capacitors.

11. The VHF band receiver according to claim 10, comprising a plurality of sets of series circuits having the one capacitor and the one switch connected in series to each other, wherein the plurality of sets of series circuits are connected in parallel to the antenna coil.

12. The VHF band receiver according to claim 10, further comprising:
a local oscillator circuit whose oscillation frequency is set by the control section; and
a mixer circuit which mixes a frequency of a local oscillation signal generated by the local oscillator circuit and a frequency of a high frequency signal obtained by a tuning operation performed by the tuning circuit.

13. The VHF band receiver according to claim 10, wherein the plurality of capacitors and the plurality of switches are formed on a semiconductor substrate having formed thereon the control section.

14. The VHF band receiver according to claim 9, wherein one end of the antenna coil is connected to the ground and the other end thereof is directly connected to the plurality of capacitors.

15. The VHF band receiver according to claim 9, wherein the antenna coil has a center tap connected to the ground and both ends thereof are directly connected to both ends of the plurality of capacitors, respectively.

16. The VHF band receiver according to claim 9, wherein:
the plurality of capacitors each have two capacitors, having the capacitance thereof set to approximately the same value, connected to each other in series; and
the connection point between the two capacitors is connected to the ground, and both ends of a series circuit constituted of the two capacitors are directly connected to both ends of the antenna coil, respectively.

17. The VHF band receiver according to claim 13, wherein constituent components except the antenna coil wound around the magnetic core are integrally formed on the semiconductor substrate by a CMOS process or a MOS process.
